(19) United States
(12) Patent Application Publication
(10) Pub. No.: US 2026/0237081 A1
(43) Pub. Date: Aug. 13, 2026

(54) PROCESSING APPARATUS, PROCESSING METHOD, AND NON-TRANSITORY COMPUTER-READABLE MEDIUM

(71) Applicant: NEC Corporation, Tokyo (JP)

(72) Inventors: Noboru YOSHIDA, Tokyo (JP); Atsushi HONDA, Tokyo (JP); Yoshihiro KAJIKI, Tokyo (JP); Takayuki KASE, Tokyo (JP); Ikumu YASUDA, Tokyo (JP); Takumi OZAKI, Tokyo (JP); Jianquan LIU, Tokyo (JP); Tingting DONG, Tokyo (JP)

(73) Assignee: NEC Corporation, Tokyo (JP)

(21) Appl. No.: 19/156,458

(22) PCT Filed: Jan. 31, 2024
(86) PCT No.: PCT/JP2024/002998

§ 371 Date: Aug. 14, 2025

(30) Foreign Application Priority Data
Mar. 16, 2023 (JP) 2023-041792

(51) Int. Cl. G06T 7/246; G06F 16/732; G06F 16/783; G06T 7/73; G06V 10/40; G06V 40/10

(52) U.S. Cl. CPC G06T 7/248; G06F 16/732; G06F 16/784; G06T 7/73; G06V 10/40; G06V 40/10; G06T 2207/10016; G06T 2207/30196; G06V 2201/07

(57) ABSTRACT

The present invention provides a processing device comprising: a reception unit which receives a user input that identifies a person to be tracked in a target frame image that is one of a plurality of time-series frame images; a detection unit which detects the person to be tracked in a plurality of near-frame images before and/or after the target frame image; an extraction unit which extracts appearance features pertaining to a plurality of items of the person to be tracked from each of the target frame image and the plurality of near-frame images; and a generation unit which integrates, for each of the items, the appearance features extracted from each of the target frame image and the plurality of near-frame images and generates a search query.

### TECHNICAL FIELD

The present invention relates to a processing device, a processing method, and a program.

### BACKGROUND ART

Techniques according to the present invention are disclosed in PTLs 1 and 2.

According to the technique disclosed in PTL 1, an object in a video designated by a user is searched for from different time zones of the video or from different videos. In a case where a user input for designating an object in a certain frame image is received, one query image is selected from a series of frame images before and after the frame image and similar image searching is executed according to the technique. More specifically, according to the technique, a frame image in which a person faces a predetermined direction is extracted from a series of preceding and subsequent frame images, and the frame image is used as a query image.

In the technique disclosed in PTL 2, a technique for tracking a target person in an image is described.

### CITATION LIST

### Patent Literature

PTL 1: JP 2015-114685 A

PTL 2: JP 2007-068008 A

### SUMMARY OF INVENTION

### Technical Problem

By executing image searching using a search query that well represents a tracking target person, it is possible to accurately detect the tracking target person from the image. The search query includes features (appearance features) related to a plurality of items that can be extracted from the appearance of a person. Examples of the plurality of items include, but are not limited to, sex, an age, hairstyle, a body shape, color of clothing, a design of clothing, color of

In the case of the technique disclosed in PTL 1, one frame image selected from a plurality of frame images is a query image. In a case where this technique is used, appearance features of a plurality of items related to the tracking target person are extracted from the one frame image. However, it is not easy to select one frame image from which appearance features of all items can be accurately extracted.

The technique disclosed in PTL 2 is not a technique for generating a search query.

In view of the above-described problems, an object of the present invention is to provide a processing device, a processing method, and a program that generate a search query capable of accurately searching for a tracking target person.

### Solution to Problem

According to an aspect of the present invention,
there is provided a processing device including
reception means for receiving a user input for designating a tracking target person in a target frame image, the target frame image being one of a plurality of chronological frame images,
detection means for detecting the tracking target person in a plurality of surrounding frame images before and/or after the target frame image,
extraction means for extracting appearance features related to a plurality of items of the tracking target person from each of the target frame image and the plurality of surrounding frame images, and
generation means for generating a search query by integrating the appearance features extracted from each of the target frame image and the plurality of surrounding frame images for each of the items.

According to another aspect of the present invention,
there is provided a processing method causing one or more computers to execute
receiving a user input for designating a tracking target person in a target frame image, the target frame image being one of a plurality of chronological frame images,
detecting the tracking target person in a plurality of surrounding frame images before and/or after the target frame image,
extracting appearance features related to a plurality of items of the tracking target person from each of the target frame image and the plurality of surrounding frame images, and
generating a search query by integrating the appearance features extracted from each of the target frame image and the plurality of surrounding frame images for each of the items.

According to still another aspect of the present invention,
there is provided a program for causing a computer to function as
reception means for receiving a user input for designating a tracking target person in a target frame image, the target frame image being one of a plurality of chronological frame images,
detection means for detecting the tracking target person in a plurality of surrounding frame images before and/or after the target frame image,
extraction means for extracting appearance features related to a plurality of items of the tracking target person from each of the target frame image and the plurality of surrounding frame images, and
generation means for generating a search query by integrating the appearance features extracted from each of the target frame image and the plurality of surrounding frame images for each of the items.

### Advantageous Effects of Invention

According to an aspect of the present invention, a processing device, a processing method, and a program that generate a search query capable of accurately searching for a tracking target person are implemented.

### BRIEF DESCRIPTION OF DRAWINGS

The above-described object and other objects, features, and advantages will be further clarified by the following public example embodiments and accompanying drawings.

FIG. 1 It is a diagram illustrating an example of a functional block diagram of a processing device.

FIG. 2 It is a diagram illustrating a process of the processing device.

FIG. 3 It is another diagram illustrating a process of the processing device.

FIG. 4 It is a diagram illustrating an example of a hardware configuration of a processing device.

FIG. 5 It is another diagram illustrating a process of the processing device.

FIG. 6 It is a flowchart illustrating an example of a processing flow of the processing device.

FIG. 7 It is another diagram illustrating a process of the processing device.

FIG. 8 It is a diagram illustrating an example of a functional block diagram of a processing device.

### EXAMPLE EMBODIMENT

Hereinafter, example embodiments of the present invention will be described with reference to the drawings. In all the drawings, the same components are denoted by the same reference numerals, and description thereof will be omitted as appropriate.

### First Example Embodiment

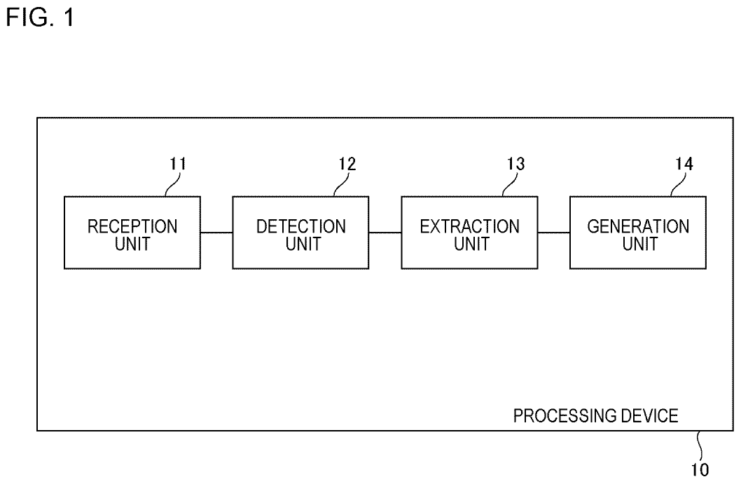

FIG. 1 is a functional block diagram illustrating an outline of a processing device 10 according to a first example embodiment. The processing device 10 includes a reception unit 11, a detection unit 12, an extraction unit 13, and a generation unit 14.

The reception unit 11 receives a user input for designating a tracking target person in a target frame image that is one of a plurality of chronological frame images. The detection unit 12 detects a tracking target person in a plurality of surrounding frame images before and/or after the target frame image. The extraction unit 13 extracts appearance features related to a plurality of items of the tracking target person from each of the target frame image and the plurality of surrounding frame images. The generation unit 14 integrates the appearance features extracted from the target frame image and the plurality of surrounding frame images for each item to generate a search query.

In this way, the processing device 10 extracts appearance features related to a plurality of items of the tracking target person from each of a plurality of frame images including the target frame image and surrounding frame images before and after the target frame image. Then, the processing device 10 integrates the appearance features extracted from the plurality of frame images for each “item” to generate a search query. According to the processing device 10 according to the present example embodiment that generates the search query according to such a characteristic scheme, it is possible to generate the search query capable of accurately searching for the tracking target person.

### Second Example Embodiment

### “Overview”

The processing device 10 according to a second example embodiment is obtained by embodying the processing device 10 according to the first example embodiment.

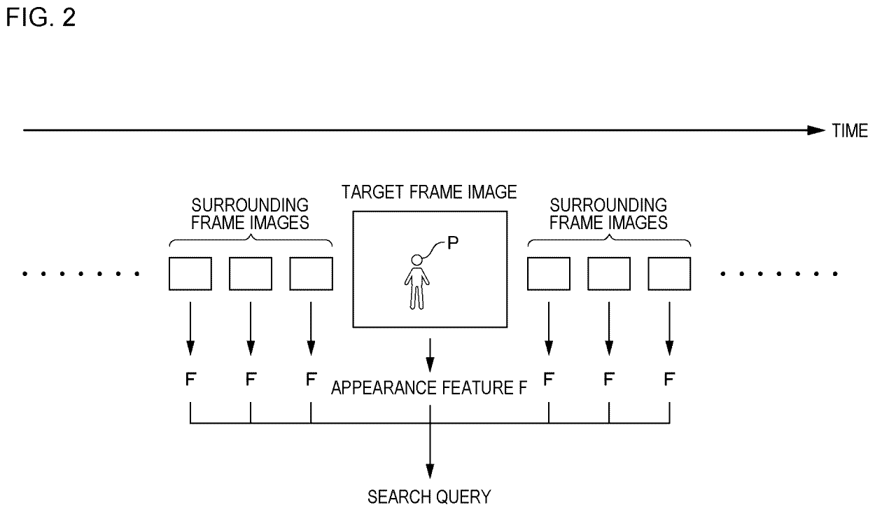

As illustrated in FIG. 2, the processing device 10 receives a user input for designating a tracking target person P in a target frame image which is one of a plurality of chronological frame images. Then, the processing device 10 detects the tracking target person P in a plurality of surrounding frame images before and/or after the target frame image.

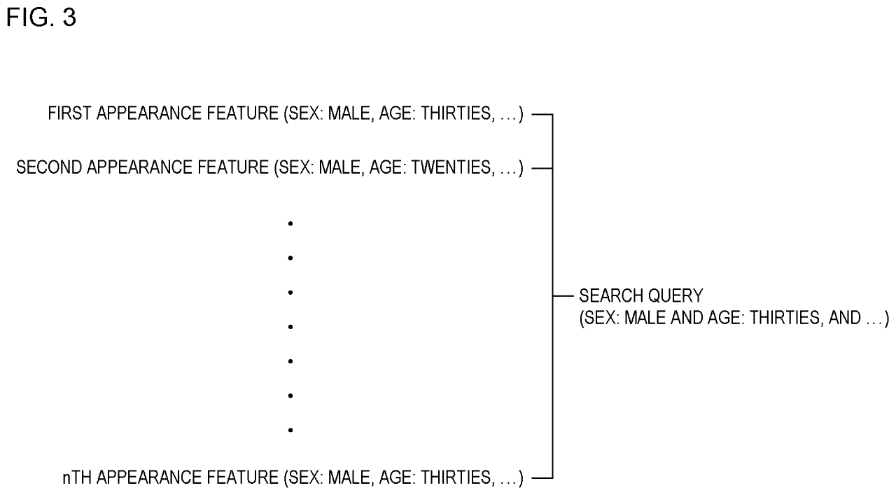

Subsequently, the processing device 10 extracts an appearance feature F of the tracking target person P from each of the target frame image and the plurality of surrounding frame images. As illustrated in FIG. 3, the appearance feature F includes information regarding a plurality of items. Examples of the plurality of items include, but are not limited to, sex, an age, hairstyle, a body shape, color of clothing, a design of clothing, color of belongings, and a design of belongings.

As illustrated in FIGS. 2 and 3, the processing device 10 integrates the appearance features F extracted from the target frame image and the plurality of surrounding frame images for each item to generate a search query.

Hereinafter, a configuration of the processing device 10 will be described in detail.

### “Hardware Configuration”

An example of a hardware configuration of the processing device 10 will be described. Each functional unit of the processing device 10 is implemented by any combination of hardware and software. It is to be understood by those skilled in the art that there are various modifications of an implementation method and the device. The software includes a program stored in advance from a stage of shipping the device, a program downloaded from a recording medium such as a compact disc (CD), a server on the Internet, or the like.

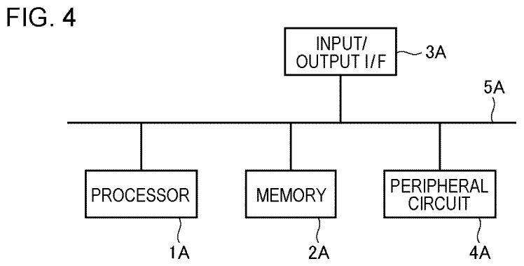

FIG. 4 is a block diagram illustrating a hardware configuration of the processing device 10. As illustrated in FIG. 4, the processing device 10 includes a processor 1A, a memory 2A, an input/output interface 3A, a peripheral circuit 4A, and a bus 5A. The peripheral circuit 4A includes various modules. The processing device 10 may not include the peripheral circuit 4A. The processing device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is, for example, an arithmetic processing unit such as a CPU or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, or the like and a camera, and an interface for outputting information to an output device, an external device, an external server, or the like. The input/output interface 3A includes an interface for connection to a communication network such as the Internet. The input device is, for example, a keyboard, a mouse, a microphone, a physical button, a touch panel, or the like. The output device is, for example, a display, a speaker, a printer, a mailer, or the like. The processor 1A can issue a command to each module and execute calculation based on a calculation result.

### “Functional Configuration”

Next, a functional configuration of the processing device 10 according to the present example embodiment will be described in detail. FIG. 1 illustrates an example of a functional block diagram of a processing device 10 according to the present example embodiment. As illustrated, the processing device 10 according to the present example embodiment includes the reception unit 11, the detection unit 12, the extraction unit 13, and the generation unit 14.

The reception unit 11 receives a user input for designating a tracking target person in a target frame image that is one of a plurality of chronological frame images. The user executes “an input for designating one of the plurality of frame images as the target frame image” and “an input for designating the tracking target person in the target frame image”.

The “input for designating one of the plurality of frame images as the target frame image” can be implemented using any technique. In an example, the user reproduces a moving image and executes an input for pausing the reproduction in a scene where the tracking target person appears. The reception unit 11 specifies the frame image displayed on the display during the pausing as the target frame image.

The input may be received from the user by another means. For example, the user may input an elapsed time from the start of the moving image. Then, the reception unit 11 may specify one frame image specified by the elapsed time as the target frame image.

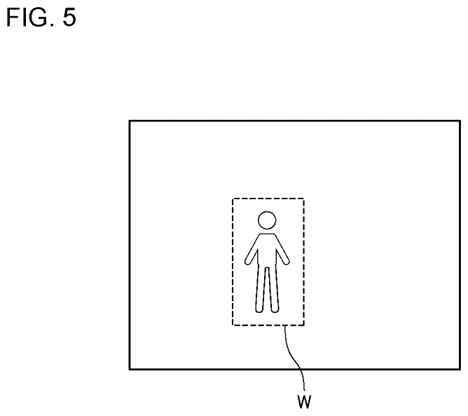

The “input for designating the tracking target person in the target frame image” can be implemented using any technique. In one example, the processing device 10 executes a person detection process on the target frame image. As illustrated in FIG. 5, the reception unit 11 overlaps and displays a rectangular area W including the detected person on the target frame image, and receives a user input for designating the rectangular area W. Although one rectangular area W is illustrated in FIG. 5, a plurality of rectangular areas W may be illustrated. The reception unit 11 specifies, as the tracking target person, a person that is in the designated rectangular area W.

The input may be received from the user by another means. For example, the user may execute an input for designating an area including the tracking target person in the target frame image. The input for designating a partial area in the image can be implemented using any technique. The processing device 10 executes a person detection process on the image in the designated area. Then, the reception unit 11 specifies the person detected in the designated area as the tracking target person.

Returning back to FIG. 1, the detection unit 12 detects the tracking target person in the plurality of surrounding frame images before and/or after the target frame image. “Before and/or after the target frame image” means before and/or after the target frame image in chronological order in the plurality of chronologically arranged frame images.

The “surrounding frame image” is one of the following frame images.
A frame image in which a target frame image in frame images from a frame image earlier than the target frame image by a first predetermined time to a frame image later than the target frame image by a second predetermined time is excluded.
A frame image from a frame image earlier than the target frame image by the first predetermined time to a frame image immediately earlier than the target frame image.
A frame image from a frame image immediately later than the target frame image to a frame image later than the target frame image by a second predetermined time.

The first predetermined time may be the same as or different from the second predetermined time. The first predetermined time and the second predetermined time may be predetermined fixed values. The first predetermined time and the second predetermined time may be changed by the user. Although described in detail in the following example embodiment, the detection unit 12 may have a function of determining the optimum first predetermined time and second predetermined time for each a processing target moving image.

The detecting of the tracking target person in each of the plurality of surrounding frame images can be implemented using any technique. For example, the detection unit 12 may detect a tracking target person in each of the plurality of surrounding frame images by tracking the tracking target person designated in the target frame image in a moving image using an object tracking technique for tracking an object in the moving image.

The extraction unit 13 extracts appearance features related to a plurality of items of the tracking target person from each of the target frame image and the plurality of surrounding frame images.

The “plurality of items” relates to features of a person that can be extracted from the appearance, that is, features of a person that can be extracted through image analysis. Examples of the plurality of items include, but are not limited to, sex, an age, hairstyle, a body shape, color of clothing, a design of clothing, color of belongings, and a design of belongings.

The appearance features that can be taken by the item “sex” are male and female.

The appearance features that can be taken by the item “age” may be age itself or ages such as teenagers and twenties.

The appearance features that can be taken by the item “hairstyle” are classifications of hairstyles such as a shaved head, a semi-long hairstyle, and the like.

The appearance features that can be taken by the item “body shape” are classifications of body shapes such as a thin type, a plump type, and the like.

The appearance features that can be taken by the item “color of clothing” may be a single color such as red or black, or may be a combination of a plurality of types of color such as red and black.

The appearance features that can be taken by the item “design of clothing” are classifications of clothing such as miniskirts, pants, T-shirts, and coats. The appearance features that can be taken by the item “design of clothing” may be obtained by further subdividing the classification of clothing. For example, the coats can be subdivided like a down coat or a duffle coat.

The appearance features that can be taken by the item “color of belongings” may be a single color such as red or black, or may be a combination of a plurality of types of color such as red and black.

The appearance features that can be taken by the item “design of belongings” are classification of belongings such as a bag and an umbrella. The appearance features that can be taken by the item “design of belongings” may be obtained by further subdividing the classification of the belongings. For example, bags can be subdivided into a backpack or a business bag. In a case where a person possesses a plurality of personal belongings, a plurality of features can be taken.

The extraction unit 13 can implement the extraction using any technique for estimating or specifying appearance features of various items of a person appearing in an image through image analysis. For example, uses of an estimation model (classifier) generated by machine learning have been exemplified, but the present invention is not limited thereto. In a case where the estimation model is used, the reliability (referred to as certainty factor or the like in some cases) of each appearance feature extracted from the image is obtained.

The generation unit 14 integrates the appearance features extracted from each of a plurality of frame images including a target frame image and a plurality of surrounding frame images for each item to generate a search query. Hereinafter, the “plurality of frame images including the target frame image and the plurality of surrounding frame images” may be simply referred to as a “plurality of frame images”.

The “integrating” executed by the generation unit 14 is to select, for each item, an appearance feature to be included in the search query from the appearance features extracted from the plurality of frame images. The generation unit 14 may select one appearance feature or may select a plurality of appearance features relevant to one item. The generation unit 14 may not select any appearance feature relevant to one item. The generation unit 14 may cause the appearance feature to be different for each item. That is, the generation unit 14 may select one appearance feature relevant to a certain item, select a plurality of appearance features relevant to other items, and may not select any appearance feature relevant to other items. The generation unit 14 generates a search query including the appearance features selected for each item in this way.

Here, a process of selecting an appearance feature included in the search query for each item from the appearance features extracted from a plurality of frame images will be described. The generation unit 14 selects at least one of the following appearance features 1 to 10 from the appearance features extracted from the plurality of frame images for each item.

The appearance feature selected for each item may be different. For example, the generation unit 14 may select appearance feature 1 in a certain item and select appearance feature 5 in another item. The generation unit 14 may select appearance feature 1 in one item and select appearance feature 2 and appearance feature 3 in another item. It is determined in advance which appearance feature is selected relevant to each item among appearance features 1 to 10. The generation unit 14 selects the appearance feature for each item according to the rule.

(Appearance feature 1) Appearance feature extracted from the largest number of frame images.

(Appearance feature 2) Appearance feature extracted from frame images equal to or more than a predetermined ratio.

(Appearance feature 3) Appearance features extracted from a predetermined number or more of frame images.

(Appearance Feature 4) Appearance Feature with highest reliability of an extraction result.

(Appearance Feature 5) Appearance feature of which reliability of an extraction result is equal to or more than a threshold.

(Appearance Feature 6) An appearance feature extracted from a frame image in which brightness of a rectangular area including a tracking target person in the frame image is highest.

(Appearance Feature 7) An appearance feature extracted from a frame image in which brightness of a rectangular area including a tracking target person in the frame image is equal to or more than the threshold.

(Appearance Feature 8) Appearance feature extracted from frame image that has a largest size of the rectangular area including the tracking target person in the frame image.

(Appearance Feature 9) An appearance feature extracted from a frame image in which a size of the rectangular area including the tracking target person in the frame image is equal to or more than the threshold.

(Appearance Feature 10) An appearance feature extracted from a frame image in which the tracking target person does not overlap another person or object in the frame image.

Appearance feature 1 is an appearance feature extracted from the largest number of frame images. The generation unit 14 selects, as appearance feature 1, an appearance feature extracted from the largest number of frame images from the appearance features extracted from the plurality of frame images.

The process of selecting appearance feature 1 may be executed using only the appearance feature of which the reliability of the extraction result output from the estimation model described above is equal to or more than a threshold among the appearance features extracted from the plurality of frame images. That is, the generation unit 14 may select, as appearance feature 1, the most frequently occurring appearance feature among those with reliability equal to or more than the threshold. The threshold is any predetermined value.

Appearance feature 2 is an appearance feature extracted from frame images equal to or more than the predetermined ratio. The generation unit 14 selects, as appearance feature 2, an appearance feature occupying a predetermined ratio or more among the appearance features extracted from the plurality of frame images. The predetermined ratio is any predetermined value. In a case where there is no appearance feature occupying the predetermined ratio or more, the generation unit 14 does not select any appearance feature as appearance feature 2.

The process of selecting appearance feature 2 may be executed using only the appearance feature of which the reliability of the extraction result output from the estimation model described above is equal to or more than the threshold among the appearance features extracted from the plurality of frame images. That is, the generation unit 14 may select, as appearance feature 2, an appearance feature occupying the predetermined ratio or more from the appearance features of which the reliability is equal to or more than the threshold. The threshold is any predetermined value.

Appearance feature 3 is an appearance feature extracted from a predetermined number or more of frame images. The generation unit 14 selects, as appearance feature 3, appearance features extracted from a predetermined number or more of frame images among appearance features extracted from the plurality of frame images. The predetermined number is any predetermined value. In a case where there is no predetermined number or more of appearance features, the generation unit 14 does not select any appearance feature as appearance feature 3.

The process of selecting appearance feature 3 may be executed using only the appearance feature of which the reliability of the extraction result output from the estimation model described above is equal to or more than the threshold among the appearance features extracted from the plurality of frame images. That is, the generation unit 14 may select, as appearance feature 3, an appearance feature extracted from the predetermined number or more of frame images in the appearance features of which the reliability is equal to or more than the threshold. The threshold is any predetermined value.

Appearance feature 4 is an appearance feature that has the highest reliability of the extraction result output from the estimation model described above. The generation unit 14 selects the appearance feature that has the highest reliability as appearance feature 4.

Appearance feature 5 is an appearance feature in which the reliability of the extraction result output from the estimation model described above is equal to or more than the threshold. The generation unit 14 selects an appearance feature of which the reliability is equal to or more than the threshold as appearance feature 5. In a case where there is no appearance feature that has reliability equal to or more than the threshold, the generation unit 14 does not select any appearance feature as appearance feature 5. The threshold is any predetermined value.

Appearance feature 6 is an appearance feature extracted from the frame image in which the brightness of the rectangular area including the tracking target person in the frame image is the highest. By executing the person detection process on the frame image, the rectangular area W including a person is detected as illustrated in FIG. 5. The generation unit 14 calculates the brightness of the rectangular area including the tracking target person detected in this way for each frame image. Then, the generation unit 14 selects, as appearance feature 6, an appearance feature extracted from a frame image in which the calculated brightness of the rectangular area is the highest from the plurality of frame images. As an index indicating the brightness of the rectangular area, brightness, luminance, luminous intensity, and the like can be used. For example, a statistical value of these indexes of pixels included in the rectangular area may be the brightness of the rectangular area. The statistical value is an average value, a median value, a mode value, a maximum value, a minimum value, or the like, but is not limited thereto.

The process of selecting appearance feature 6 may be executed using only the appearance feature of which the reliability of the extraction result output from the estimation model described above is equal to or more than the threshold among the appearance features extracted from the plurality of frame images. That is, the generation unit 14 may select, as appearance feature 6, an appearance feature extracted from a frame image that has the brightest rectangular area from the appearance features of which the reliability is equal to or more than the threshold. The threshold is any predetermined value.

Appearance feature 7 is an appearance feature extracted from a frame image of which the brightness of the rectangular area including the tracking target person in the frame image is equal to or more than the threshold. The generation unit 14 selects an appearance feature extracted from the frame image of which the brightness is equal to or more than the threshold as appearance feature 7. In a case where there is no frame image of which the brightness is equal to or more than the threshold, the generation unit 14 does not select any appearance feature as appearance feature 7. The threshold is any predetermined value.

The process of selecting appearance feature 7 may be executed using only the appearance feature of which the reliability of the extraction result output from the estimation model described above is equal to or more than the threshold among the appearance features extracted from the plurality of frame images. That is, the generation unit 14 may select, as appearance feature 7, an appearance feature extracted from a frame image of which the brightness is equal to or more than the threshold from the appearance features of which the reliability is equal to or more than the threshold. The threshold is any predetermined value.

Appearance feature 8 is an appearance feature extracted from the frame image in which the size of the rectangular area including the tracking target person in the frame image is the largest. The generation unit 14 selects an appearance feature extracted from the frame image that has the largest size as appearance feature 8. The size of the rectangular area can be indicated by, for example, the number of pixels included in the rectangular area.

The process of selecting appearance feature 8 may be executed using only the appearance feature of which the reliability of the extraction result output from the estimation model described above is equal to or more than the threshold among the appearance features extracted from the plurality of frame images. That is, the generation unit 14 may select, as appearance feature 8, an appearance feature extracted from a frame image that has the largest size from the appearance features of which the reliability is equal to or more than the threshold. The threshold is any predetermined value.

Appearance feature 9 is an appearance feature extracted from a frame image in which the size of the rectangular area including the tracking target person in the frame image is equal to or more than the threshold. The generation unit 14 selects an appearance feature extracted from the frame image that has the size equal to or more than the threshold as appearance feature 9. In a case where there is no frame image that has the size equal to or more than the threshold, the generation unit 14 does not select any appearance feature as appearance feature 9. The threshold is any predetermined value.

The process of selecting appearance feature 9 may be executed using only the appearance feature of which the reliability of the extraction result output from the estimation model described above is equal to or more than the threshold among the appearance features extracted from the plurality of frame images. That is, the generation unit 14 may select, as appearance feature 9, an appearance feature extracted from the frame image of which a size is equal to or more than a threshold from the appearance features of which the reliability is equal to or more than the threshold. The threshold is any predetermined value.

Appearance feature 10 is an appearance feature extracted from a frame image in which the tracking target person does not overlap another person or object in the frame image. The generation unit 14 determines, for each frame image, whether the tracking target person overlaps another person or object. Then, the generation unit 14 specifies, as appearance feature 10, an appearance feature extracted from a frame image in which the tracking target person does not overlap another person or object in the frame image.

The process of determining whether the tracking target person overlaps another person or object in the frame image can be implemented using any technique. For example, the generation unit 14 may execute an object detection process on the frame image and specify a rectangular area including a person or an object. Then, based on whether the rectangular area of the specified person or object and the rectangular area including the tracking target person overlap each other, it may be determined whether the tracking target person does not overlap another person or object in the frame image. For example, in a case where the rectangular area of the specified person or object and the rectangular area including the tracking target person overlap each other, it can be determined that the tracking target person overlaps another person or object in the frame image.

Next, a process of generating a search query including an appearance feature selected for each item will be described. The generation unit 14 generates a search query by connecting appearance features selected for each item using a predetermined logical operator by a predetermined rule.

For example, the generation unit 14 generates a condition (condition for each item) for each item based on a result of integrating the appearance features for each item. Then, the generation unit 14 connects conditions using a predetermined logical operator (for example, an AND condition) to generate the search query.

The condition for each item may be a condition in which one appearance feature is set for one item, such as “sex: male”. The generation unit 14 may select a plurality of appearance features relevant to one item. The condition for each item in this case may be a condition in which a plurality of appearance features are connected by an OR condition. The generation unit 14 may not select any appearance feature relevant to one item. In this case, the generation unit 14 can generate a search query that does not include the condition for each item in the item.

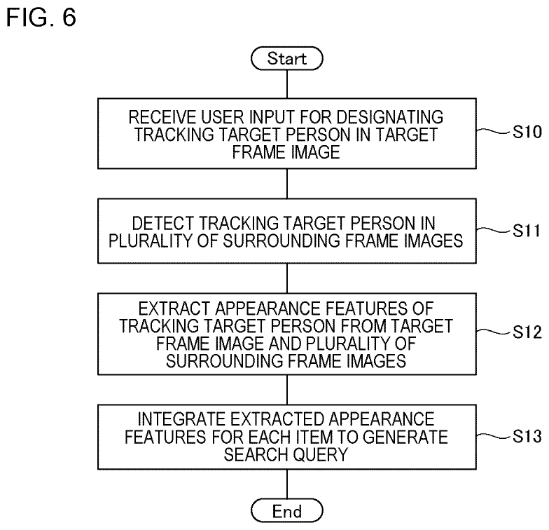

Next, an example of a flow of a process of the processing device 10 will be described with reference to the flowchart of FIG. 6.

First, the processing device 10 receives a user input for designating the tracking target person in a target frame image that is one of a plurality of chronological frame images (S10). Subsequently, the processing device 10 detects the tracking target person in the plurality of surrounding frame images before and/or after the target frame image (S11). Subsequently, the processing device 10 extracts appearance features related to a plurality of items of the tracking target person from each of the target frame image and the plurality of surrounding frame images (S12). Then, the processing device 10 integrates the appearance features extracted from each of the target frame image and the plurality of surrounding frame images for each item to generate a search query (S13).

### “Operations and Effects”

The processing device 10 according to the present example embodiment generates the search query for detecting the tracking target person based on the target frame image designated by the user and the plurality of surrounding frame images before and/or after the target frame image. Specifically, the processing device 10 extracts the appearance features of the tracking target person from each of the plurality of frame images including the target frame image and the plurality of surrounding frame images. Then, the processing device 10 integrates the appearance features extracted from the plurality of frame images for each item to generate the search query.

According to the processing device 10 that generates the search query based on such a plurality of frame images, it is possible to generate the search query that can accurately search for the tracking target person even when there is no one frame image that can accurately extract the appearance features of all the items. According to the processing device 10 that integrates the appearance features for each item, the appearance features extracted from the plurality of frame images can be integrated more flexibly. As a result, it is possible to generate the search query capable of more accurately searching for the tracking target person.

The processing device 10 selects at least one of appearance features 1 to 10 described above from the appearance features extracted from the plurality of frame images, and generates the search query including the selected appearance features. Then, the processing device 10 can cause the integration scheme to be different for each item. According to the processing device 10, it is possible to generate the search query capable of searching for the tracking target person more accurately.

### Third Example Embodiment

The processing device 10 according to the present example embodiment is different from the processing device 10 according to the second example embodiment in content of a process of selecting an appearance feature included in a search query from appearance features extracted from a plurality of frame images. Details will be described below.

The generation unit 14 calculates, for each item, an evaluation value of each of the plurality of appearance features extracted from the target frame image and the plurality of surrounding frame images. Then, the generation unit 14 selects an appearance feature of which the evaluation value satisfies a predetermined condition, and generates a search query including the selected appearance feature. The predetermined condition is not limited to a case where the evaluation value is equal to or more than the threshold. The threshold is any predetermined value. As described above, the generation unit 14 is different from that of the second example embodiment in the content of the process of selecting the appearance feature included in the search query. A scheme of generating the search query including the selected appearance feature is similar to that of the second example embodiment.

Hereinafter, a process of selecting an appearance feature included in the search query, more specifically, a process of calculating an evaluation value will be described in detail.

The generation unit 14 calculates an evaluation value for each appearance feature of each item based on at least one of the following.
the number of extracted frame images.
reliability of an extraction result output from the estimation model described in the second example embodiment.
brightness of the rectangular area in the frame image including the tracking target person.
a size of the rectangular area in the frame image including the tracking target person.
whether the tracking target person overlaps another person or object in the frame image.
From which of the target frame image and the plurality of surrounding frame images it was extracted.
a direction of the tracking target person.
a chronological order of the extracted frame image within the target frame image and the plurality of surrounding frame images.

The generation unit 14 calculates an evaluation value based on a predetermined evaluation value calculation model. The evaluation value calculation model may be a function, may be a table in which content and an evaluation value are associated with each other, or may be another.

The evaluation value calculation model may be configured to calculate a higher evaluation value for an appearance feature extracted from more frame images. A search query that accurately represents the tracking target person can be generated by evaluating the reliable appearance features extracted from more frame images more highly.

The evaluation value calculation model may be configured to calculate a higher evaluation value for an appearance feature for which higher reliability of an extraction result is obtained. A search query that accurately represents the tracking target person can be generated by evaluating the appearance feature that has higher reliability of the extraction result more highly.

The evaluation value calculation model may be configured to calculate a higher evaluation value for an appearance feature extracted from a frame image of which brightness of a rectangular area in the frame image including the tracking target person is higher. It is conceivable that the brighter the inside of the rectangular area is, the better the feature of the appearance of the tracking target person appears. A search query that accurately represents the tracking target person can be generated by evaluating the appearance features extracted from the brighter rectangular area more highly.

The evaluation value calculation model may be configured to calculate a higher evaluation value for an appearance feature extracted from a frame image that has a larger rectangular area in the frame image including the tracking target person. It is conceivable that the larger the rectangular area is, the better the feature of the appearance of the tracking target person appears. A search query that accurately represents the tracking target person can be generated by evaluating the appearance features extracted from a larger rectangular area more highly.

The evaluation value calculation model may be configured to calculate a higher evaluation value for an appearance feature extracted from a frame image in which the tracking target person does not overlap another person or object, as compared with an appearance feature extracted from a frame image in which the tracking target person overlaps another person or object. In a case where the tracking target person does not overlap another person or object, the feature of the appearance of the tracking target person can be more accurately extracted than a case where the tracking target person overlaps another person or object. A search query that accurately represents the tracking target person can be generated by more highly evaluating an appearance feature extracted from a frame image in which the tracking target person does not overlap another person or object.

The evaluation value calculation model may be configured to calculate a higher evaluation value for the appearance feature extracted from the target frame image, as compared with the appearance feature extracted from the surrounding frame image. By evaluating the appearance feature extracted from the target frame image designated by the user higher than the appearance feature extracted from the surrounding frame image not designated by the user, it is possible to generate the search query more appropriate for an intention of the user.

The evaluation value calculation model may be configured to calculate a higher evaluation value for an appearance feature extracted from a frame image in which the tracking target person is in the predetermined direction than an appearance feature extracted from a frame image in which the tracking target person is not in the predetermined direction. The predetermined direction is, for example, a front direction (a state of facing the camera), but the present invention is not limited thereto. In a case where the tracking target person is in the predetermined direction, the appearance features of the tracking target person can be extracted more accurately. A search query that accurately represents the tracking target person can be generated by more highly evaluating the appearance features extracted from the frame image in which the tracking target person is in the predetermined direction.

Here, a process of calculating the evaluation value based on the “chronological order of the extracted frame images in the target frame image and the plurality of surrounding frame images” will be described.

In this example, the generation unit 14 first generates at least one of the first search query and the second search query. The first search query is a search query used in a process of searching for the tracking target person in the frame images chronologically later than the target frame image. The second search query is a search query used in a process of searching for the tracking target person in the frame images chronologically earlier than the target frame image.

In the generating of the first search query, the generation unit 14 calculates a higher evaluation value for the appearance feature extracted from the frame image with a later chronological order in the plurality of frame images including the target frame image and the plurality of surrounding frame images (first calculation process).

In the generating of the second search query, the generation unit 14 calculates a higher evaluation value for the appearance feature extracted from the frame image of which a chronological order is earlier in the plurality of frame images including the target frame image and the plurality of surrounding frame images (second calculation process).

The generation unit 14 can execute at least one of the first calculation process and the second calculation process.

The appearance features of the tracking target person may change over time. For example, the appearance features of the tracking target person may change due to disguise, leaving of belongings, transfer of belongings, or the like. In consideration of this point, in the process of searching for the tracking target person in the frame images chronologically later than the target frame image, the appearance feature extracted from a newer frame image is useful. In the process of searching for the tracking target person in the frame images chronologically earlier than the target frame image, the appearance feature extracted from an earlier frame image is useful. By calculating the evaluation value in consideration of such a point, a search query that can accurately detect the tracking target person is generated.

Other configurations of the processing device 10 are similar to those of the first and second example embodiments.

According to the processing device 10 of the present example embodiment, operational effects similar to those of the first and second example embodiments are implemented. The processing device 10 according to the present example embodiment calculates the evaluation value of each of the plurality of appearance features extracted from the target frame image and the plurality of surrounding frame images by the above-described characteristic scheme, and selects the appearance feature included in the search query based on the evaluation value. According to the processing device 10, it is possible to generate the search query capable of accurately searching for the tracking target person.

### Fourth Example Embodiment

The processing device 10 according to the present example embodiment integrates appearance features of a plurality of items by a plurality of different schemes. Details will be described below.

The generation unit 14 integrates the appearance features of the plurality of items by a plurality of different schemes. The generation unit 14 integrates the appearance features of the first item by a first scheme and integrates the appearance features of the second item by a second scheme. The first scheme is different from the second scheme. The generation unit 14 may classify a plurality of items into two items of first and second items and integrate appearance features of each item by a scheme relevant to each classification. Additionally, the generation unit 14 may classify a plurality of items into three or more items and integrate appearance features of each item by a scheme relevant to each classification.

Classification content of the plurality of items and an integration scheme relevant to each classification are determined in advance and registered in the processing device 10. The generation unit 14 specifies classification to which each item belongs and specifies an integration scheme relevant to each classification based on the information.

The integration scheme relevant to each classification may be, for example, any of the integration schemes described in the second and third example embodiments. That is, the integration scheme relevant to certain classification may be any of the integration schemes described in the second and third example embodiments, and the integration scheme relevant to another classification may be any of the integration schemes described in the second and third example embodiments.

Here, another specific example of the integration scheme relevant to each classification will be described. In this example, the plurality of items are classified into two first and second items.

The first item is an item that it is physically impossible for one person to have a plurality of appearance features, such as gender, age, hairstyle, and body shape. In the first scheme relevant to the first item, the generation unit 14 selects at least one of the plurality of appearance features extracted from the target frame image and the plurality of surrounding frame images for each item. Then, the generation unit 14 generates a condition for each item including at least one of the selected features, and generates a search query including the condition for each item. The first scheme is the integration scheme described in the second and third example embodiments.

The second item is an item in which one person can physically have a plurality of appearance features, such as the color of clothing, the design of clothing, the color of belongings, and the design of belongings. In a second scheme relevant to the second item, the generation unit 14 generates, for each item, an item-by-item condition including all of a plurality of appearance features extracted from the target frame image and the plurality of surrounding frame images. For example, the generation unit 14 generates a condition for each item that connects all of the plurality of extracted appearance features under an OR condition. Then, the generation unit 14 generates a search query including the condition for each item.

Other configurations of the processing device 10 are similar to those of the first to third example embodiments.

According to the processing device 10 of the present example embodiment, operational effects similar to those of the first to third example embodiments are implemented. The processing device 10 according to the present example embodiment can integrate the appearance features of each item by a scheme appropriate for features of each item to generate a search query. According to the processing device 10, it is possible to generate the search query capable of accurately searching for the tracking target person.

### Fifth Example Embodiment

The processing device 10 according to the present example embodiment determines a frame image included in a surrounding frame image based on an analysis result of a moving image. Details will be described below.

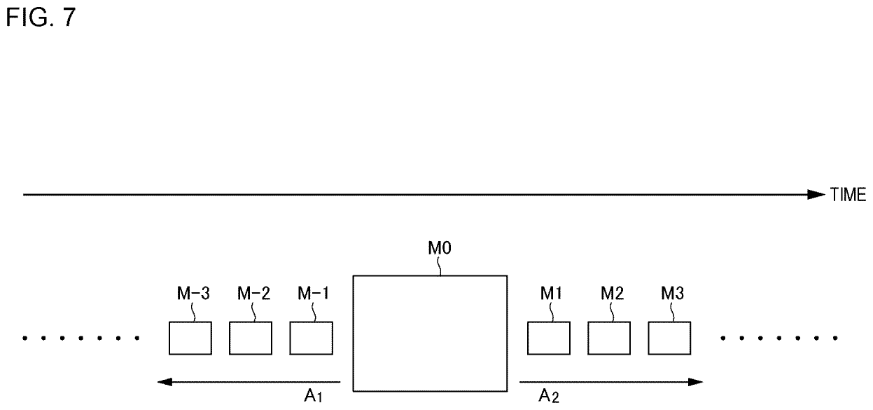

In a case where frame images chronologically earlier than the target frame image are included in the surrounding frame images, the detection unit 12 determines whether each frame image satisfies a predetermined stop condition while chronologically tracing back in sequence from the frame image M₋₁ immediately earlier than a target frame image M₀, as illustrated in FIG. 7. That is, the detection unit 12 sequentially determines whether each frame image satisfies the predetermined stop condition while tracing back in the direction of an arrow A1 from a frame image M₋₁ immediately earlier than the target frame image M₀. Then, the detection unit 12 determines that “the frame image M₋₁” to “a frame image determined to satisfy the stop condition Nth” are included in the surrounding frame images. N is any integer of 1 or more.

In a case where the frame images chronologically later than the target frame image are included in the surrounding frame images, the detection unit 12 determines whether each frame image satisfies the predetermined stop condition in chronological order from the frame image M₁ immediately later than the target frame image M₀ as illustrated in FIG. 7. That is, the detection unit 12 determines whether each frame image satisfies the predetermined stop condition in sequence from the frame image M₁ immediately later than the target frame image M₀ in the direction of the arrow A2. Then, the detection unit 12 determines that “frame image M₁” to “a frame image determined to satisfy the stop condition Nth” are included in the surrounding frame images. N is any integer of 1 or more.

The detection unit 12 determines a frame image included in the plurality of surrounding frame images based on at least one of the following features of frame images other than the target frame image. The stop condition is defined by at least one of the following features.
brightness of the rectangular area including the tracking target person in the frame image
a size of the rectangular area including the tracking target person in the frame image
whether the tracking target person overlaps another person or object in the frame image.
an orientation of the tracking target person in the frame image

The stop condition may be that the brightness of the rectangular area is equal to or more than a threshold. The threshold is any predetermined value.

Additionally, the stop condition may be that the size of the rectangular area is equal to or more than a threshold. The threshold is any predetermined value.

Additionally, the stop condition may be that the tracking target person does not overlap another person or object in the frame image.

Additionally, the stop condition may be that the direction of the tracking target person in the frame image is a predetermined direction. The predetermined direction is a front direction (a state of facing the camera), but the present invention is not limited thereto.

Additionally, the stop condition may be that there are a plurality of frame images in which the direction of the tracking target person in the frame image is each of a plurality of predetermined directions are determined in the determination executed so far in sequence from the frame image immediately earlier or immediately later than the target frame image. The plurality of predetermined directions are, but not limited to, a front direction, a back direction, a right side direction, a left side direction, and the like.

Additionally, the stop condition may be a condition in which two or more of the plurality of stop conditions described above are connected using any logical operator.

Other configurations of the processing device 10 are similar to those of the first to fourth example embodiments.

According to the processing device 10 of the present example embodiment, operational effects similar to those of the first to fourth example embodiments are implemented. The processing device 10 according to the present example embodiment can determine a frame image included in the surrounding frame image based on an analysis result of a moving image. According to the processing device 10, it is possible to generate the search query capable of accurately searching for the tracking target person.

### Sixth Example Embodiment

The processing device 10 according to the present example embodiment determines whether to execute the above-described “integration of appearance features extracted from a plurality of frame images” for each item, and generates a search query by the determined scheme. Details will be described below.

For an item in which the reliability of the appearance feature extracted from the target frame designated by the user is equal to or more than the threshold, the generation unit 14 generates the search query including the appearance feature in the condition for each item. That is, for such an item, the generation unit 14 does not execute “integration of the appearance features extracted from a plurality of frame images”.

On the other hand, for an item in which the reliability of the appearance feature extracted from the target frame designated by the user is less than the threshold, the generation unit 14 executes “integration of the appearance features extracted from the plurality of frame images”. The generation unit 14 can execute the integration by the scheme described in the above example embodiment.

The reliability is reliability of an extraction result output from the estimation model described in the second example embodiment. The threshold is any predetermined value.

Other configurations of the processing device 10 are similar to those of the first to fifth example embodiments.

According to the processing device 10 of the present example embodiment, operational effects similar to those of the first to fifth example embodiments are implemented. For an item in which the appearance features with high reliability are extracted from the target frame designated by the user, the processing device 10 according to the present example embodiment generates a search query using the appearance features. For an item in which the appearance feature with high reliability is not extracted from the target frame designated by the user, the processing device 10 integrates the appearance features extracted from the target frame image and the plurality of surrounding frame images to generate the search query. According to the processing device 10, it is possible to generate a search query by which an intention of the user is better matched and the tracking target person can be accurately searched for.

### Seventh Example Embodiment

The processing device 10 according to the present example embodiment searches for the tracking target person using the search query generated by the generation unit 14. Details will be described below.

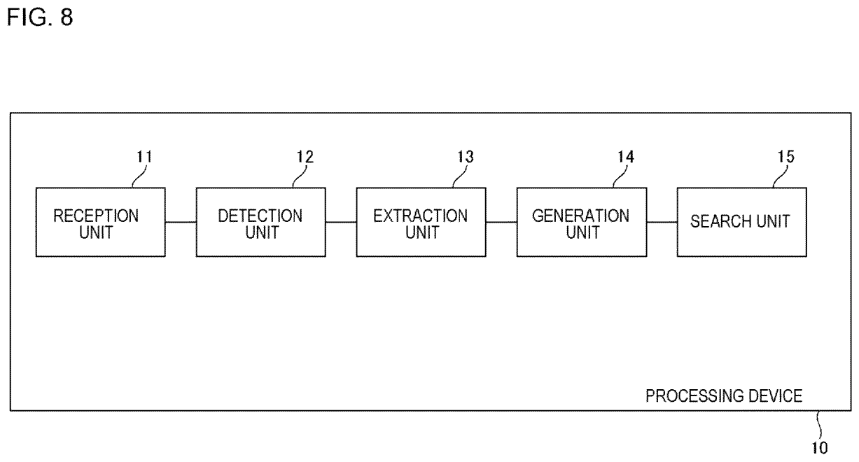

FIG. 8 illustrates an example of a functional block diagram of the processing device 10 according to the present example embodiment. As illustrated, the processing device 10 according to the present example embodiment includes a reception unit 11, a detection unit 12, an extraction unit 13, a generation unit 14, and a search unit 15.

The search unit 15 searches for the tracking target person from a moving image using the search query generated by the generation unit 14. That is, the search unit 15 searches for a person having appearance features indicated by the search query in the moving image. The moving image that is a search target may be a moving image including the target frame image and the surrounding frame images. The moving image that is the search target may be a moving image that does not include the target frame image and the surrounding frame images.

The search unit 15 searches for a person satisfying a condition of the appearance features indicated by the search query generated by the generation unit 14 in the moving image. The searching is implemented using any technique.

Other configurations of the processing device 10 are similar to those of the first to sixth example embodiments.

According to the processing device 10 of the present example embodiment, operational effects similar to those of the first to sixth example embodiments are implemented. The processing device 10 according to the present example embodiment searches for the tracking target person using the search query generated by the characteristic scheme as described in the above example embodiment. According to the processing device 10, it is possible to accurately search for the tracking target person.

### Modifications

Modifications are applicable to the first to seventh example embodiments. In the modifications, the generation unit 14 regenerates the search query using the search result by the search unit 15 according to the seventh example embodiment.

First, the generation unit 14 generates a search query by any of the schemes described in the first to sixth example embodiments. Then, the search unit 15 searches for the tracking target person using the search query.

Thereafter, the generation unit 14 regenerates the search query using the search result by the search unit 15. Specifically, the generation unit 14 acquires a frame image used for regenerating the search query among a plurality of frame images included in the search result by the search unit 15.

For example, the generation unit 14 may display a plurality of frame images included in the search result by the search unit 15 on the display, and receive a user input for designating a frame image used for regenerating the search query among the plurality of frame images. In this case, the generation unit 14 acquires the frame image designated by the user input as the frame image used for regenerating the search query. The user designates a frame image including the tracking target person among the plurality of frame images displayed on the display.

Additionally, the generation unit 14 may calculate similarity in appearance between a human figure included in the plurality of frame images included in the search result and a human figure who is a tracking target designated by the user input received by the reception unit 11. Then, the generation unit 14 may acquire the frame image that has the similarity equal to or more than the threshold as the frame image used for regenerating the search query. The threshold is any predetermined value. The similarity is implemented using any technique for calculating similarity in appearances of a person. For example, a technique for calculating similarity of the face of a person may be used.

After the frame image used for regenerating the search query is acquired from the plurality of frame images included in the search result by the search unit 15, the extraction unit 13 extracts appearance features related to a plurality of items of the tracking target person from each of the acquired frame images. Then, the generation unit 14 integrates the target frame image, the plurality of surrounding frame images, and the appearance features extracted from each of the acquired frame images for each item to generate the search query. The integration scheme is similar to that of the first to seventh example embodiments.

The processing device 10 may execute the searching again using the regenerated search query and may regenerate the search query based on the search result. Then, the processing device 10 may repeat this loop a plurality of times.

According to the modification, the search query can be generated based on the appearance of the tracking target person in more frame images. As a result, it is possible to generate the search query capable of accurately searching for the tracking target person.

Although the example embodiments of the present invention have been described above with reference to the drawings, these are examples of the present invention, and various configurations other than the above can also be used. The configurations of the above-described example embodiments may be combined with each other, or some of the configurations may be replaced with other configurations. The configurations of the above-described example embodiments may be modified in various forms within a range without departing from the gist. The configurations and processes disclosed in the above-described example embodiments and modifications may be combined with each other.

In the flowchart used in the above description, a plurality of steps (processes) are described in order. However, an execution order of the steps executed in each example embodiment is not limited to the described order. In each example embodiment, the order of the illustrated steps can be changed within a range in which there is no problem in terms of content. The above-described example embodiments can be combined within a range in which the contents are not contradictory.

Some or all of the above example embodiments may be described as the following supplementary notes, but are not limited to the following.

1. A processing device including:
reception means for receiving a user input for designating a tracking target person in a target frame image, the target frame image being one of a plurality of chronological frame images;
detection means for detecting the tracking target person in a plurality of surrounding frame images before and/or after the target frame image;
extraction means for extracting appearance features related to a plurality of items of the tracking target person from each of the target frame image and the plurality of surrounding frame images; and
generation means for generating a search query by integrating the appearance features extracted from each of the target frame image and the plurality of surrounding frame images for each of the items.

2. The processing device according to 1, wherein
the generation means selects at least one of:
for each of the items, from the plurality of appearance features extracted from the target frame image and the plurality of surrounding frame images,
the appearance feature extracted from the largest number of frame images,
the appearance features extracted from the frame images equal to or more than a predetermined ratio,
the appearance features extracted from a predetermined number or more of frame images,
the appearance feature having highest reliability of an extraction result,
the appearance features of which the reliability of the extraction result is equal to or more than a threshold,
the appearance feature extracted from a frame image in which brightness of a rectangular area including the tracking target person in the frame image is highest,
the appearance feature extracted from a frame image in which brightness of a rectangular area including the tracking target person in the frame image is equal to or more than a threshold,
the appearance feature extracted from a frame image in which a size of a rectangular area including the tracking target person in the frame image is largest,
the appearance feature extracted from a frame image in which a size of a rectangular area including the tracking target person in the frame image is equal to or more than a threshold, and
the appearance feature extracted from a frame image in which the tracking target person does not overlap another person or object in the frame image,
to generate the search query including the selected appearance feature.

3. The processing device according to 1, wherein
the generation means
calculates, for each of the items, an evaluation value of each of the plurality of appearance features extracted from the target frame image and the plurality of surrounding frame images, and generates the search query including the appearance features in which the evaluation value satisfies a predetermined condition, and
calculates the evaluation value based on at least one of the number of extracted frame images, reliability of an extraction result, brightness of a rectangular area in a frame image including the tracking target person, a size of the rectangular area in the frame image including the tracking target person, whether the tracking target person overlaps another person or an object in the frame image, whether the tracking target person is extracted from the target frame image or the plurality of surrounding frame images, and a chronological order in the target frame image and the plurality of surrounding frame images of the extracted frame image.

4. The processing device according to 3, wherein
the generation means executes at least one of:
a process of calculating the evaluation value is higher by the appearance feature extracted from a frame image chronologically later than the target frame image and the plurality of surrounding frame images in the generating of the search query for searching for the tracking target person in a frame image chronologically later than the target frame image, and
a process of calculating the evaluation value is higher by the appearance feature extracted from a frame image chronologically earlier than the target frame image and the plurality of surrounding frame images in the generating of the search query for searching for the tracking target person in a frame image chronologically earlier than the target frame image.

5. The processing device according to 4, wherein
the generation means
generates at least one of the search query used in the process of searching for the tracking target person in frame images chronologically later than the target frame image and the search query used in the process of searching for the tracking target person in frame images chronologically earlier than the target frame image.

6. The processing device according to any one of 1 to 5, wherein
the generation means integrates the appearance features of a first item by a first scheme and integrates the appearance features of a second item by a second scheme, and
the first and second schemes are different.

7. The processing device according to 6, wherein
in the first scheme, the generation means selects at least one of the plurality of appearance features extracted from the target frame image and the plurality of surrounding frame images, and generates the search query including the selected at least one of the selected appearance features, and
in the second scheme, the generation means generates the search query including a plurality of the appearance features extracted from the target frame image and the plurality of surrounding frame images.

8. The processing device according to any one of 1 to 7, wherein
the detection means determines a frame image included in the plurality of surrounding frame images based on at least one of:
brightness of a rectangular area including the tracking target person in the frame image among frame images other than the target frame image,
a size of the rectangular area including the tracking target person in the frame image,
whether the tracking target person overlaps another person or object in the frame image, and
an orientation of the tracking target person in the frame image.

9. A processing method causing one or more computers to execute:
receiving a user input for designating a tracking target person in a target frame image, the target frame image being one of a plurality of chronological frame images;
detecting the tracking target person in a plurality of surrounding frame images before and/or after the target frame image;
extracting appearance features related to a plurality of items of the tracking target person from each of the target frame image and the plurality of surrounding frame images; and
generating a search query by integrating the appearance features extracted from each of the target frame image and the plurality of surrounding frame images for each of the items.

10. A program that causes a computer to function as:
reception means for receiving a user input for designating a tracking target person in a target frame image, the target frame image being one of a plurality of chronological frame images;
detection means for detecting the tracking target person in a plurality of surrounding frame images before and/or after the target frame image;
extraction means for extracting appearance features related to a plurality of items of the tracking target person from each of the target frame image and the plurality of surrounding frame images; and
generation means for generating a search query by integrating the appearance features extracted from each of the target frame image and the plurality of surrounding frame images for each of the items.

This application is based upon and claims the benefit of priority from Japanese patent application No. 2023-041792, filed on Mar. 16, 2023, the disclosure of which is incorporated herein in its entirety by reference.

### REFERENCE SIGNS LIST

10 processing device
11 reception unit
12 detection unit
13 extraction unit
14 generation unit
15 search unit
1A processor
2A memory
3A input/output I/F
4A peripheral circuit
5A bus

What is claimed is:

1. A processing apparatus comprising:
at least one memory configured to store one or more instructions; and
at least one processor configured to execute the one or more instructions to:
receive a user input for designating a tracking target person in a target frame image, the target frame image being one of a plurality of chronological frame images;
detect the tracking target person in a plurality of surrounding frame images before and/or after the target frame image;
extract appearance features related to a plurality of items of the tracking target person from each of the target frame image and the plurality of surrounding frame images; and
generate a search query by integrating the appearance features extracted from each of the target frame image and the plurality of surrounding frame images for each of the items.

2. The processing apparatus according to claim 1, wherein
the at least one processor is further configured to execute the one or more instructions to select at least one of:
for each of the items, from the plurality of appearance features extracted from the target frame image and the plurality of surrounding frame images,
the appearance feature extracted from the largest number of frame images,
the appearance features extracted from the frame images equal to or more than a predetermined ratio,
the appearance features extracted from a predetermined number or more of frame images,
the appearance feature having highest reliability of an extraction result,
the appearance features of which the reliability of the extraction result is equal to or more than a threshold,
the appearance feature extracted from a frame image in which brightness of a rectangular area including the tracking target person in the frame image is highest,
the appearance feature extracted from a frame image in which brightness of a rectangular area including the tracking target person in the frame image is equal to or more than a threshold,
the appearance feature extracted from a frame image in which a size of a rectangular area including the tracking target person in the frame image is largest,
the appearance feature extracted from a frame image in which a size of a rectangular area including the tracking target person in the frame image is equal to or more than a threshold, and
the appearance feature extracted from a frame image in which the tracking target person does not overlap another person or object in the frame image,
to generate the search query including the selected appearance feature.

3. The processing apparatus according to claim 1, wherein
the at least one processor is further configured to execute the one or more instructions to
calculate, for each of the items, an evaluation value of each of the plurality of appearance features extracted from the target frame image and the plurality of surrounding frame images,
generate the search query including the appearance features in which the evaluation value satisfies a predetermined condition, and
calculate the evaluation value based on at least one of the number of extracted frame images, reliability of an extraction result, brightness of a rectangular area in a frame image including the tracking target person, a size of the rectangular area in the frame image including the tracking target person, whether the tracking target person overlaps another person or an object in the frame image, whether the tracking target person is extracted from the target frame image or the plurality of surrounding frame images, and a chronological order in the target frame image and the plurality of surrounding frame images of the extracted frame image.

4. The processing apparatus according to claim 3, wherein
the at least one processor is further configured to execute the one or more instructions to execute at least one of:
a process of calculating the evaluation value is higher by the appearance feature extracted from a frame image chronologically later than the target frame image and the plurality of surrounding frame images in the generating of the search query for searching for the tracking target person in a frame image chronologically later than the target frame image, and
a process of calculating the evaluation value is higher by the appearance feature extracted from a frame image chronologically earlier than the target frame image and the plurality of surrounding frame images in the generating of the search query for searching for the tracking target person in a frame image chronologically earlier than the target frame image.

5. The processing apparatus according to claim 4, wherein
the at least one processor is further configured to execute the one or more instructions to generate
at least one of the search query used in the process of searching for the tracking target person in frame images chronologically later than the target frame image and the search query used in the process of searching for the tracking target person in frame images chronologically earlier than the target frame image.

6. The processing apparatus according to claim 1, wherein
the at least one processor is further configured to execute the one or more instructions to generate the appearance features of a first item by a first scheme and integrate the appearance features of a second item by a second scheme, and
the first and second schemes are different.

7. The processing apparatus according to claim 6, wherein the at least one processor is further configured to execute the one or more instructions to,
in the first scheme, select at least one of the plurality of appearance features extracted from the target frame image and the plurality of surrounding frame images, and generate the search query including the selected at least one of the selected appearance features, and
in the second scheme, generate the search query including a plurality of the appearance features extracted from the target frame image and the plurality of surrounding frame images.

8. The processing apparatus according to claim 1, wherein
the at least one processor is further configured to execute the one or more instructions to determine a frame image included in the plurality of surrounding frame images based on at least one of:
brightness of a rectangular area including the tracking target person in the frame image among frame images other than the target frame image,
a size of the rectangular area including the tracking target person in the frame image,
whether the tracking target person overlaps another person or object in the frame image, and
an orientation of the tracking target person in the frame image.

9. A processing method causing one or more computers to execute:
receiving a user input for designating a tracking target person in a target frame image, the target frame image being one of a plurality of chronological frame images;
detecting the tracking target person in a plurality of surrounding frame images before and/or after the target frame image;
extracting appearance features related to a plurality of items of the tracking target person from each of the target frame image and the plurality of surrounding frame images; and
generating a search query by integrating the appearance features extracted from each of the target frame image and the plurality of surrounding frame images for each of the items.

10. The processing method according to claim 9, wherein
the one or more computers selects at least one of:
for each of the items, from the plurality of appearance features extracted from the target frame image and the plurality of surrounding frame images,
the appearance feature extracted from the largest number of frame images,
the appearance features extracted from the frame images equal to or more than a predetermined ratio,
the appearance features extracted from a predetermined number or more of frame images,
the appearance feature having highest reliability of an extraction result,
the appearance features of which the reliability of the extraction result is equal to or more than a threshold,
the appearance feature extracted from a frame image in which brightness of a rectangular area including the tracking target person in the frame image is highest,
the appearance feature extracted from a frame image in which brightness of a rectangular area including the tracking target person in the frame image is equal to or more than a threshold,
the appearance feature extracted from a frame image in which a size of a rectangular area including the tracking target person in the frame image is largest,
the appearance feature extracted from a frame image in which a size of a rectangular area including the tracking target person in the frame image is equal to or more than a threshold, and
the appearance feature extracted from a frame image in which the tracking target person does not overlap another person or object in the frame image,
to generate the search query including the selected appearance feature.

11. The processing method according to claim 9, wherein
the one or more computers
calculates, for each of the items, an evaluation value of each of the plurality of appearance features extracted from the target frame image and the plurality of surrounding frame images,
generates the search query including the appearance features in which the evaluation value satisfies a predetermined condition, and
calculates the evaluation value based on at least one of the number of extracted frame images, reliability of an extraction result, brightness of a rectangular area in a frame image including the tracking target person, a size of the rectangular area in the frame image including the tracking target person, whether the tracking target person overlaps another person or an object in the frame image, whether the tracking target person is extracted from the target frame image or the plurality of surrounding frame images, and a chronological order in the target frame image and the plurality of surrounding frame images of the extracted frame image.

12. The processing method according to claim 11, wherein
the one or more computers execute at least one of:
a process of calculating the evaluation value is higher by the appearance feature extracted from a frame image chronologically later than the target frame image and the plurality of surrounding frame images in the generating of the search query for searching for the tracking target person in a frame image chronologically later than the target frame image, and
a process of calculating the evaluation value is higher by the appearance feature extracted from a frame image chronologically earlier than the target frame image and the plurality of surrounding frame images in the generating of the search query for searching for the tracking target person in a frame image chronologically earlier than the target frame image.

13. The processing method according to claim 12, wherein
the one or more computers
generate at least one of the search query used in the process of searching for the tracking target person in frame images chronologically later than the target frame image and the search query used in the process of searching for the tracking target person in frame images chronologically earlier than the target frame image.

14. The processing method according to claim 9, wherein
the one or more computers integrate the appearance features of a first item by a first scheme and integrate the appearance features of a second item by a second scheme, and
the first and second schemes are different.

15. A non-transitory computer-readable medium storing a program that causes a computer to:
receive a user input for designating a tracking target person in a target frame image, the target frame image being one of a plurality of chronological frame images;
detect the tracking target person in a plurality of surrounding frame images before and/or after the target frame image;
extract appearance features related to a plurality of items of the tracking target person from each of the target frame image and the plurality of surrounding frame images; and
generate a search query by integrating the appearance features extracted from each of the target frame image and the plurality of surrounding frame images for each of the items.

16. The non-transitory computer-readable medium according to claim 15, wherein
the program causes the computer to select at least one of:
for each of the items, from the plurality of appearance features extracted from the target frame image and the plurality of surrounding frame images,
the appearance feature extracted from the largest number of frame images,
the appearance features extracted from the frame images equal to or more than a predetermined ratio,
the appearance features extracted from a predetermined number or more of frame images,
the appearance feature having highest reliability of an extraction result,
the appearance features of which the reliability of the extraction result is equal to or more than a threshold,
the appearance feature extracted from a frame image in which brightness of a rectangular area including the tracking target person in the frame image is highest,
the appearance feature extracted from a frame image in which brightness of a rectangular area including the tracking target person in the frame image is equal to or more than a threshold,
the appearance feature extracted from a frame image in which a size of a rectangular area including the tracking target person in the frame image is largest,
the appearance feature extracted from a frame image in which a size of a rectangular area including the tracking target person in the frame image is equal to or more than a threshold, and
the appearance feature extracted from a frame image in which the tracking target person does not overlap another person or object in the frame image,
to generate the search query including the selected appearance feature.

17. The non-transitory computer-readable recording medium according to claim 15, wherein
the program causes the computer to
calculate, for each of the items, an evaluation value of each of the plurality of appearance features extracted from the target frame image and the plurality of surrounding frame images,
generate the search query including the appearance features in which the evaluation value satisfies a predetermined condition, and
calculate the evaluation value based on at least one of the number of extracted frame images, reliability of an extraction result, brightness of a rectangular area in a frame image including the tracking target person, a size of the rectangular area in the frame image including the tracking target person, whether the tracking target person overlaps another person or an object in the frame image, whether the tracking target person is extracted from the target frame image or the plurality of surrounding frame images, and a chronological order in the target frame image and the plurality of surrounding frame images of the extracted frame image.

18. The non-transitory computer-readable medium according to claim 17, wherein
the program causes the computer to execute at least one of:
a process of calculating the evaluation value is higher by the appearance feature extracted from a frame image chronologically later than the target frame image and the plurality of surrounding frame images in the generating of the search query for searching for the tracking target person in a frame image chronologically later than the target frame image, and
a process of calculating the evaluation value is higher by the appearance feature extracted from a frame image chronologically earlier than the target frame image and the plurality of surrounding frame images in the generating of the search query for searching for the tracking target person in a frame image chronologically earlier than the target frame image.

19. The non-transitory computer-readable medium according to claim 18, wherein
the program causes the computer to
generate at least one of the search query used in the process of searching for the tracking target person in frame images chronologically later than the target frame image and the search query used in the process of searching for the tracking target person in frame images chronologically earlier than the target frame image.

20. The non-transitory computer-readable medium according to claim 15, wherein
the program causes the computer to integrate the appearance features of a first item by a first scheme and integrate the appearance features of a second item by a second scheme, and
the first and second schemes are different.
